(19) United States
(12) Patent Application Publication
(10) Pub. No.: US 2004/0070393 A1
(43) Pub. Date: Apr. 15, 2004

(54) Differential measurement method using eddy-current sensing to resolve a stack of conducting films on substrates

(76) Inventors: Moshe Sarfaty, Cupertino, CA (US); Ramaswamy Sreenivasan, Greenbelt, MD (US); Cuong Duy Le, Morgan Hill, CA (US)

Correspondence Address: PATENT COUNSEL, APPLIED MATERIALS, INC., Legal Affairs Department, P.O.Box 450A, Santa Clara, CA, 95052, US

(21) Appl. No.: 10/409,619

(22) Filed: Apr. 8, 2003

Related U.S. Application Data
(60) Provisional application No. 60/371,281, filed on Apr. 8, 2002.

(51) Int. Cl. G01B 7/06

(52) U.S. Cl. 324/230; 324/662; 324/716

(57) ABSTRACT

In a first aspect, a method of inspecting objects is provided. The method includes the steps of (1) measuring sheet resistance of a first stack of conducting films deposited on an object, said first stack having a topmost conducting film; (2) depositing a subsequent conducting film on said first stack of conducting films to form a second stack; (3) measuring sheet resistance of said second stack; and (4) calculating sheet resistance of the subsequent conducting film. A thickness of the subsequent conducting film may be determined based on the sheet resistance of the subsequent conducting film. Numerous other aspects are provided.

The present application claims priority from U.S. Provisional Patent Application Serial No. 60/371,281, filed Apr. 8, 2002, which is hereby incorporated by reference herein in its entirety.

### BACKGROUND OF THE INVENTION

1. Field of the Invention

The present invention relates to a method for determining the thickness of each conducting film of a stack of conducting films, each deposited on and in electrical contact with another.

2. Description of the Related Art

In the semiconductor manufacturing process, conducting films often are deposited on semiconductor wafers, etched, and overlaid by additional conducting films. Quality and thickness of conducting films is important to the manufacturing process, and it is of particular interest to measure the thickness of conducting films quickly and accurately. Conducting films can serve as barrier, adhesion or seed layers. Each of these layers typically is composed of different materials, each material having different properties, including resistivity. Resistivity is an intrinsic property of a material defined as its resistance to current per unit length for a uniform cross section. Sheet resistance of a conducting film is defined as resistivity divided by the thickness of the film. Thus, by measuring sheet resistance, it is possible to measure conducting film thickness.

Conducting film thickness may be measured by inducing eddy currents in a conducting film and measuring the strength of those eddy currents. An eddy current sensor having a driver coil and a detector coil may be used to induce the eddy currents. The driver coil is connected to a power source used to excite the coil at radio frequencies (and induce eddy currents in the conducting film). The detector coil is connected to circuitry for measuring the magnitude of the induced eddy currents.

The magnitude of the eddy currents relates to the strength of the magnetic field produced by the driver coil and to the sheet resistance of the conducting film. The strength of the magnetic field relates to the driver current, the physical characteristics of the driver coil including the number of turns and the impedance of the driver coil, and the distance between the eddy current sensor and the conducting film. Because the sheet resistance relates to the resistivity of the conducting film material, the thickness of the conducting film, and the frequency of the magnetic field, sheet resistance may be used to determine film thickness.

Because the physical properties including resistivity of the conducting film are known, and the characteristics of the eddy current sensor coils are known, the conducting film thickness relates to the proximity of the eddy current sensor to the conducting film. Knowing the distance between the sensor and the film, the film thickness then may be determined. Techniques for measuring the distance from a sensor to a conducting surface are well known in the art. For example, U.S. Pat. No. 4,727,322 issued to Lonchampt et al. discloses an eddy current probe that is moved normal to an inspection surface using a mechanical positioning device providing a distance measurement. In U.S. Pat. No. 4,849,694 issued to Coates, an optical microscope objective lens is used to accurately position an eddy current probe. Further, in U.S. Pat. No. 5,525,903 issued to Mandl et al., the distance from an eddy current probe to a conducting surface is measured using an integral capacitance probe.

However, when a second conducting film is deposited on top of and in electrical contact with a first conducting film of differing material, the resulting film thickness measurement accurately reflects neither the overall thickness, nor the individual thickness of the first or the second conducting films.

### SUMMARY OF THE INVENTION

The present invention discloses a method to overcome this deficiency and to measure the thickness of each conducting film deposited during the manufacturing of an integrated circuit. In a first aspect, the present invention discloses a method whereby the thickness of each conducting film of a stack of conducting films may be determined. In order to measure the sheet resistance of a conducting film deposited on an already deposited stack of one or more conducting films, the sheet resistance of the stack before deposition of the topmost film is calculated. Then, the sheet resistance of the stack after deposition of the topmost film is calculated. Knowing these two values, the sheet resistance of the topmost film then may be computed, and knowing the resistivity of the topmost film material, the thickness of the topmost film may be determined.

Other features and aspects of the present invention will become more fully apparent from the following detailed description, the appended claims and the accompanying drawings.

### BRIEF DESCRIPTION OF THE DRAWINGS

These and other features and benefits of the invention will be readily appreciated in light of the following detailed description of the preferred embodiments thereof, given by way of example only with reference to the accompanying drawings wherein:

FIG. 1 shows an inspection system for implementing the inventive method for a first conducting film;

FIG. 2 shows an inspection system for implementing the inventive method for a subsequent conducting film; and

FIG. 3 shows a flow chart representing the inventive method.

### DETAILED DESCRIPTION OF THE PREFERRED EMBODIMENTS

Preferred embodiments of the present invention will now be described with reference to the attached drawings, wherein identical elements are designated with like numerals.

Eddy currents are induced and measured by an eddy current sensor having a driver coil and a detector coil, although the driver coil and the detector coil may be the same coil. Further, the eddy current sensor also may have an integral capacitance probe for measuring the proximity of the sensor to the conducting film. Although a internal capacitance probe for measuring distance is provided, any other suitable apparatus and/or method for measuring distance may be used. One such exemplary apparatus and/or method is described in U.S. Patent Application Serial No. 60/371,267, filed Apr. 8, 2002, which is hereby incorporated by reference herein in its entirety.

The total sheet resistance of a stack of conducting films is similar to the total resistance of parallel resistors. Specifically, the reciprocal of the total resistance is the sum of the reciprocal of each individual resistor. This relationship is expressed mathematically as follows:

$$\frac{1}{{R}_{total}} = {\sum }_{i = 1}^{n} \frac{1}{{R}_{i}}$$

where

Rₜₒₜₐₗ is the sheet resistance of the stack of conducting films,

Rᵢ is the sheet resistance for an individual conducting film, and

n is the total number of conducting films comprising a stack of conducting films.

According to the inventive method, when a first conducting film is deposited, the sheet resistance may be measured using an eddy current sensor. The value of this sheet resistance is retained as previous sheet resistance (Rₚ). After a second film (now the topmost film) is deposited, the total sheet resistance (Rₜ) of all (e.g., both) films is measured using the eddy current sensor. The sheet resistance of the second, topmost film (Rᵢ) may then be calculated. The total sheet resistance (due to the first and second films), Rₜ, is then retained as the previous sheet resistance, Rₚ, and the process of depositing additional films continues with calculations being made for the sheet resistance of each successive film. In this manner, the sheet resistance for each film, Rᵢ, may be computed. Once the sheet resistance of each film and the resistivity of each film material are known, the thickness of each film may be computed.

The sheet resistance of the topmost conducting film being deposited (Rᵢ) may be calculated using the following relationship:

$${R}_{i} = \frac{{R}_{p} \times {R}_{t}}{{R}_{p} - {R}_{t}}$$

where

Rᵢ is the sheet resistance of the topmost film deposited,

Rₜ is the total measured sheet resistance including the last (topmost) film deposited, and

Rₚ is the measured sheet resistance prior to the last (topmost) film being deposited.

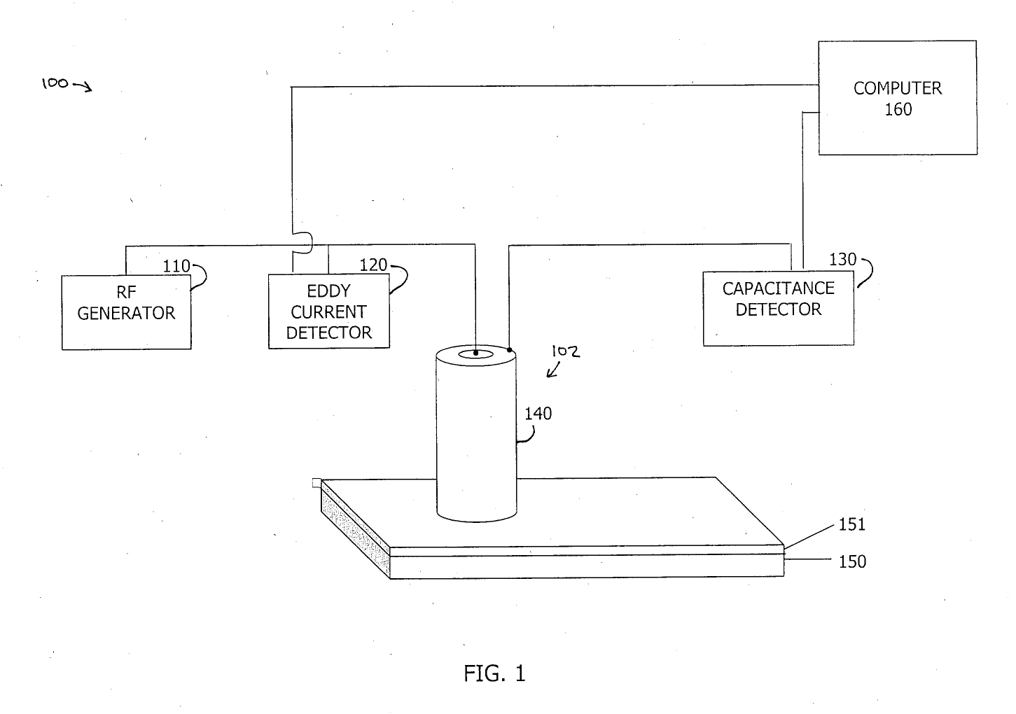

FIG. 1 shows an exemplary system 100 for implementing the inventive method. An object such as a semiconductor wafer, glass plate or other substrate, referred to as substrate 150, is placed in a chamber, not shown, for vacuum deposition of a first conducting film 151. Other deposition techniques may be employed. After deposition of the first conducting film 151, an eddy current sensor 102 having a capacitance probe 140 measures the sheet resistance of the first conducting film 151 by having an RF generator 110 induce eddy currents in the conducting film 151. Other types of eddy current sensors (e.g., without integrated capacitance probes) may be employed. These eddy currents are in turn detected by an eddy current detector 120. The magnitude of the eddy currents is then passed to a computer or other controller 160 for further computation. The sensor 102 also measures capacitance that relates to the proximity of the sensor 102 to the conducting film 151. The capacitance varies inversely with the distance between the conducting film 151 and the eddy current-capacitance sensor 102. Capacitance detection circuitry 130 senses the capacitance and from this capacitance, the distance between the sensor and the film may be determined, for example, by the computer or controller 160 which can make such a calculation. From the strength of the eddy currents and the distance of the sensor 102 to the conducting film 151, the sheet resistance of the conducting film 151 may be determined. By knowing the resistivity of the conducting film material, the thickness of the conducting film 151 may be determined.

After determining the sheet resistance of the first conducting film 151, the value of this sheet resistance is retained as a previous sheet resistance, Rₚ (and may be used to determine the film thickness of the first conducting film 151).

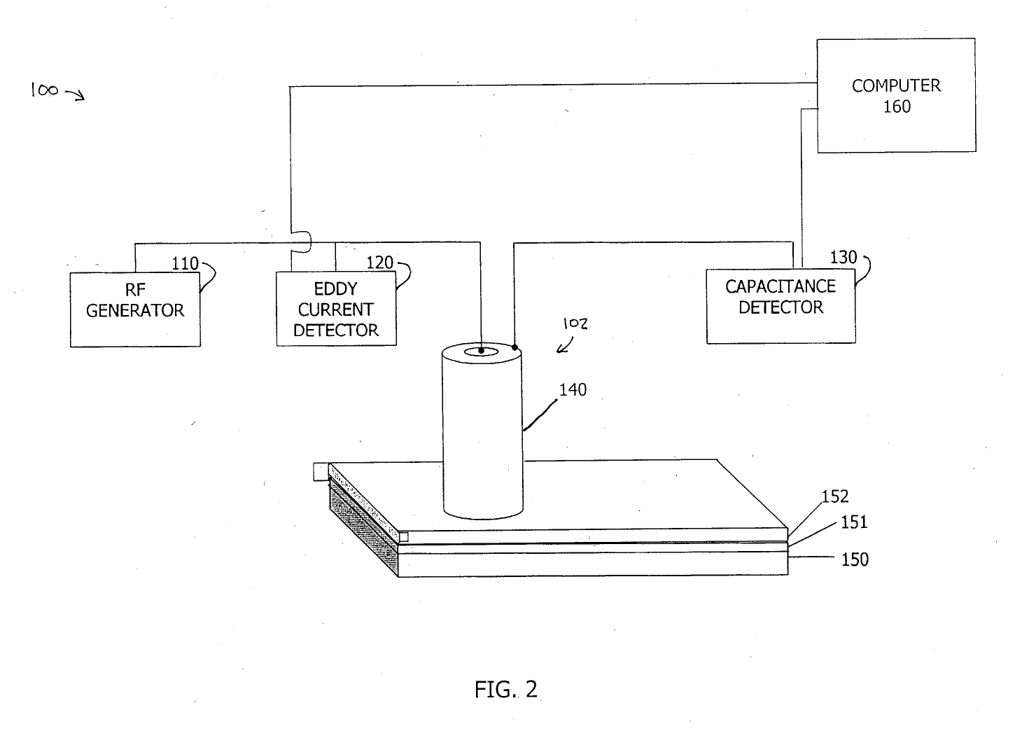

Referring to FIG. 2, if a subsequent conducting film 152 is deposited, the total sheet resistance, Rₜ, of the subsequent conducting film 152 and all prior conducting films (e.g., the first conducting film 151 in this case) may be measured using the same procedure as described above. Now, having the total sheet resistance of the stack of conducting films, Rₜ, and the previous sheet resistance, Rₚ, the sheet resistance of the subsequent conducting film 152, Rᵢ, may be computed using the following relationship:

$${R}_{i} = \frac{{R}_{p} \times {R}_{t}}{{R}_{p} - {R}_{t}}$$

Having calculated the subsequent conducting film 152 sheet resistance, Rᵢ, the value for the total sheet resistance, Rₜ, is now retained as the new value for the previous sheet resistance, Rₚ. Rᵢ may be also retained for future calculations to determine film thickness of the conducting film 152.

The above procedure may be performed for each conducting film that is subsequently deposited on the substrate 150.

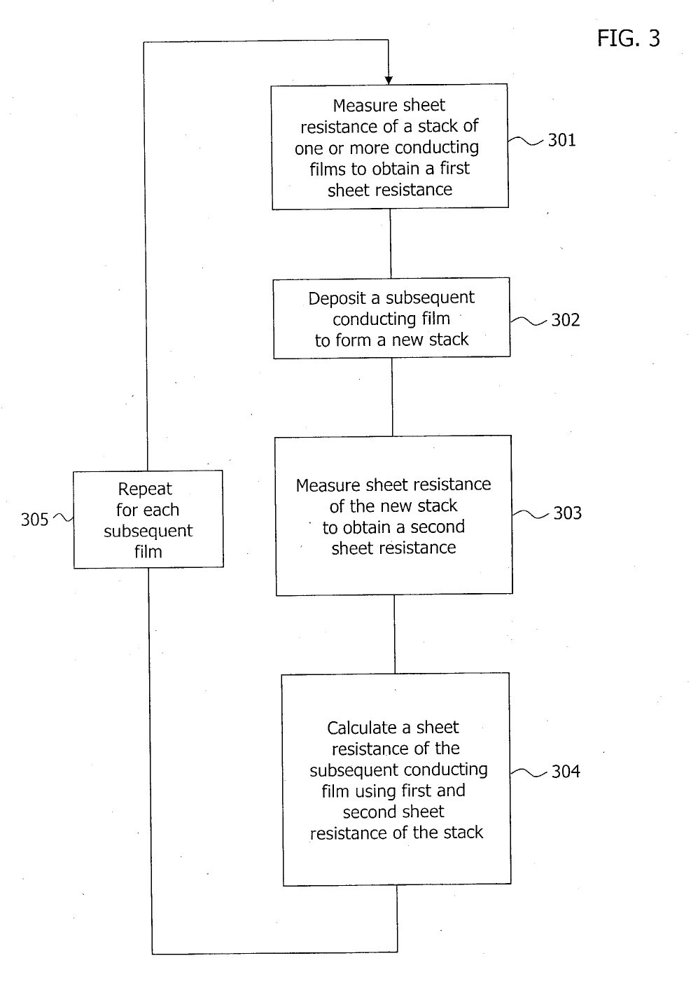

The flowchart shown in FIG. 3 depicts the steps to calculate the sheet resistance of individual conducting films of a stack of one or more conducting films. Each of the steps of this flowchart has been described above. Briefly, in step 301 a first sheet resistance is measured from a stack of one or more conducting films. After subsequent conducting film deposition (step 302), in step 303 a second sheet resistance is measured for the new stack which now includes the sheet resistance of the subsequent conducting film. Then, in step 304, using the first and second sheet resistances, the sheet resistance of the subsequent conducting film is calculated. Step 305 causes the process to be repeated as necessary. Note that the second sheet resistance employed in step 304 may be used as a new “first” sheet resistance and only steps 302-304 repeated for the next, subsequently deposited conducting film (rather than repeating step 301). The computer or controller 160 may comprise, for example, one or more conventional microprocessors and/or controllers, a dedicated logic circuit, a combination thereof, etc. In at least one embodiment of the invention, the computer or controller 160 may include suitable computer program code for performing one or more of the steps of FIG. 3 or otherwise described herein.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

The foregoing description discloses only exemplary embodiments of the invention. Modifications of the above disclosed apparatus and method which fall within the scope of the invention will be readily apparent to those of ordinary skill in the art. For instance, the thickness of a subsequent conducting film may be determined once the sheet resistance of the subsequent conducting film is determined. Also, because conducting films may be deposited on substrates having different doping levels (and thus different resistivities), it may be desirable to obtain a sheet resistance measurement of a substrate prior to deposition of a conducting film on the substrate. Contributions of the resistivity of the substrate thereby may be resolved, factored into and/or removed from subsequent conducting film resistivity/thickness calculations. An eddy current measurement also may be employed to determine a doping level of a substrate (e.g., based on the sheet resistance). A single eddy current sensor may be employed to determine sheet resistance and/or thickness of a conducting film at multiple locations across a substrate (e.g., by translating the sensor relative to the substrate or vice versa). Likewise, an array of eddy current sensors may be employed to determine sheet resistance and/or thickness of a conducting film at multiple locations across a substrate (e.g., simultaneously).

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

The invention claimed is:

1. A method of inspecting objects, said method comprising:
a. measuring sheet resistance of a first stack of conducting films deposited on an object, said first stack having a topmost conducting film;
b. depositing a subsequent conducting film on said first stack of conducting films to form a second stack;
c. measuring sheet resistance of said second stack; and
d. calculating sheet resistance of the subsequent conducting film based on the sheet resistance of the first stack and the sheet resistance of the second stack.

2. The method of claim 1, wherein measuring sheet resistance of said first stack of conducting films deposited on said object further comprises:
a1. detecting an eddy current of said first conducting film deposited on said object induced by an eddy current coil disposed within a sensor, said sensor having a position relative to said object to be inspected;
a2. measuring a distance between said sensor and said object; and
a3. determining sheet resistance of said first stack of conducting films.

3. The method of claim 2, wherein said measuring said distance further comprises using a capacitance probe.

4. The method of claim 1, wherein measuring sheet resistance of said second stack of conducting films further comprises:
c1. detecting an eddy current of said second stack of conducting films induced by an eddy current coil disposed within a sensor, said sensor having a position relative to said object to be inspected;
c2. measuring a distance between said sensor and said object; and
c3. determining sheet resistance of said second stack of conducting films.

5. The method of claim 4, wherein said measuring said distance further comprises using a capacitance probe.

6. The method of claim 1, wherein the object is a semiconductor wafer.

7. The method of claim 1, wherein said first stack of conducting films comprises a single conducting film.

8. The method of claim 1, wherein said first stack of conducting films comprises a plurality of conducting films.

9. The method of claim 1, wherein said subsequent conducting film comprises the same material as said topmost conducting film.

10. The method of claim 1, wherein said subsequent conducting film comprises a different material than said topmost conducting film.

11. The method of claim 1, wherein steps a through d are repeated for each subsequent film deposited.

12. The method of claim 1, further comprising determining a thickness of the subsequent conducting film based on the sheet resistance of the subsequent conducting film.

13. The method of claim 1, further comprising determining a thickness of the topmost conducting film of the first stack of conducting films.

14. A method of inspecting objects, said method comprising:
a. measuring sheet resistance of a first stack of conducting films deposited on an object, said first stack having a topmost conducting film;
b. measuring sheet resistance of a second stack of conducting films formed by depositing a subsequent conducting film on said first stack;
and
c. calculating sheet resistance of the subsequent conducting film.

15. The method of claim 14 further comprising determining a thickness of the subsequent conducting film based on the sheet resistance of the subsequent conducting film.

16. An apparatus comprising:
a sensor adapted to measure a sheet resistance of a stack of conducting films; and
a controller coupled to the sensor, the controller having computer program code adapted to direct the controller to:
a. measure sheet resistance of a first stack of conducting films deposited on an object using the sensor, said first stack having a topmost conducting film;
b. measure sheet resistance of a second stack of conducting films using the sensor, the second stack of conducting films formed by depositing a subsequent conducting film on said first stack; and
c. calculate sheet resistance of the subsequent conducting film.

17. The apparatus of claim 16 wherein the controller includes computer program code adapted to direct the controller to determine a thickness of the subsequent conducting film based on the sheet resistance of the subsequent conducting film.
